(19) United States
(12) Patent Application Publication
(10) Pub. No.: US 2026/0328399 A1
(43) Pub. Date: Oct. 22, 2026

(54) Cooking Utensil and Door Lock Apparatus Thereof and Door Locking Method Therefor, and Lock Hook Position Detection Method

(71) Applicant: NINGBO DAOKANG INTELLIGENT TECHNOLOGY CO., LTD., Ningbo (CN)

(72) Inventors: HAODONG XU, Ningbo (CN); YUANPEI ZHAO, Ningbo (CN)

(21) Appl. No.: 19/550,242

(22) Filed: Feb. 25, 2026

Related U.S. Application Data
(63) Continuation of application No. PCT/CN2023/127968, filed on Oct. 30, 2023.

(30) Foreign Application Priority Data
Sep. 1, 2023 (CN) 202311128476.9
Sep. 1, 2023 (CN) 202322376476.2
Oct. 30, 2023 (WO) PCT/CN2023/127968

(51) Int. Cl. F24C 15/02; E05B 15/10; E05B 47/00

(52) U.S. Cl. CPC F24C 15/022; E05B 15/10; E05B 47/0012

(57) ABSTRACT

A door lock apparatus for cooking utensil includes a stepping electric motor assembly which is used to drive a locking end of a lock hook to swing, such that the locking end of the lock hook can hook or release a locking lug of a door. Compared with an conventional manner in which a door lock requires a synchronous electric motor to provide a driving force, a low-voltage direct-current is used to supply power to the stepping electric motor assembly of the door lock apparatus, such that it is not necessary to carry out a high-voltage protection treatment on the door lock apparatus, which can not only reduce the cost of the door lock apparatus, but can also improve the safety of the door lock apparatus and avoid potential safety hazards caused by electric leakage.

### CROSS REFERENCE OF RELATED APPLICATION

This is a Continuation Application of PCT/CN2023/127968, filing date Oct. 30, 2023, which claims priority under 35 U.S.C. 119(a-d) to Chinese application numbers CN202311128476.9, filing date Sep. 1, 2023; and CN202322376476.2, filing date Sep. 1, 2023, 2024, the afore-mentioned patent applications are hereby incorporated by reference in their entireties.

### BACKGROUND OF THE PRESENT INVENTION

### Field of Invention

The present invention relates to relates to a door lock, and more particularly to a cooking utensil and its door lock apparatus, door locking method, and lock hook position detection method.

### Description of Related Arts

Ovens and other cooking utensils are common household appliances. During use, the cooking space inside these appliances typically reaches high temperatures, posing a certain degree of danger. Therefore, cooking utensils must be locked when in operation to prevent users from opening the door and suffering burns or scalds from entering the cooking space. In other words, a door lock is an essential feature of cooking utensils. FIG. 1 shows a conventional door lock which comprises a lock body 10P, a lock hook 20P, a transmission part 30P, a synchronous motor 40P, and a plurality of micro switches 50P. The lock hook 20P is oscillatingly mounted on the lock body 10P. The transmission part 30P is connected to the output shaft of the synchronous motor 40P and the lock hook 20P. The micro switches 50P are respectively disposed on the lock body 10P and located near the transmission part 30P. When mains power is supplied to the synchronous motor 40P, the output shaft of the synchronous motor 40P outputs power, which is transmitted to the lock hook 20P through the transmission part 30P to drive the lock hook 20P to oscillate with respect to the lock body 10P, so that the lock hook 20P can hook or release the door latch. In this process, the transmission part 30P triggers the micro switches 50P to determine whether the lock hook 20P has oscillated to the designed position based on the signal generated by the micro switches 50P. The conventional door lock technology has many defects.

First, this door lock requires multiple microswitches 50P to be installed on the lock body 10P, resulting in a complex structure and high cost. Second, the microswitches 50P need to be exposed to high temperatures for extended periods, making them prone to failure. If a microswitch 50P fails, the lock will be unable to determine whether the lock hook 20P has swung to its designed position. Third, the door lock is powered by a synchronous motor 40P. Since this motor requires mains power, which has a relatively high voltage, high-voltage protection is necessary, leading to excessively high costs and a potentially fatal danger to the user should an electrical leak occur. Fourth, when the synchronous motor 40P drives the lock hook 20P to swing through the transmission part 30P, the transmission part 30P triggers the micro switch 50P. The door lock determines whether the lock hook 20P has swung to the designed position based on the signal generated by the micro switch 50P. That is, as long as the transmission part 30P triggers the micro switch 50P, the door lock will determine whether the lock hook 20P has swung to the designed position, regardless of whether the lock hook 20P hooks or releases the door's locking bolt. However, in actual use, especially when the door needs to be locked, if the door's locking bolt has not moved to the corresponding position, for example, if the door is not closed properly, when the synchronous motor 40P drives the lock hook 20P to swing through the transmission part 30P and triggers the micro switch 50P, the cooking utensil will also show the result that the door is locked, but in reality, the door is not locked by the door lock. This can lead to the cooking utensil being accidentally opened by the user during operation, which poses a significant safety hazard to the user.

### SUMMARY OF THE PRESENT INVENTION

An object of the present invention is to provide a cooking utensil and its door lock apparatus, locking method, and lock hook position detection method. The door lock apparatus uses a stepper motor assembly to drive the locking end of a lock hook to swing, so that the locking end of the lock hook can hook or release a door latch. Compared with the conventional door locks that require a synchronous motor to provide driving force, the stepper motor assembly of the door lock apparatus of the present invention is powered by low-voltage DC power, so that the door lock apparatus does not need high-voltage protection. This not only reduces the cost of the door lock apparatus, but also improves the safety of the door lock apparatus and avoids safety hazards caused by leakage.

An object of the present invention is to provide a cooking utensil and its door lock apparatus, locking method and lock hook position detection method, wherein when the stepper motor assembly drives the locking end of the lock hook to swing through a rotation transmission element and a sliding transmission element, the lock hook can be determined to have reached the target position by judging whether the stepper motor assembly is stalled. This eliminates the need for a micro switch in the door lock apparatus, thereby simplifying the structure of the door lock apparatus and reducing its cost.

An object of the present invention is to provide a cooking utensil and its door lock apparatus, locking method, and lock hook position detection method. Since the door lock apparatus of the present invention does not require the configuration of a micro switch, it is not necessary to consider whether the micro switch is triggered during the rotation of the rotation transmission element. This improves the design flexibility of the rotation transmission element. In this way, the stepper motor assembly can be located away from the heat source of the cooking utensil, allowing the stepper motor assembly to operate in a low-temperature environment, which helps to extend the life of the stepper motor assembly and improve its reliability.

An object of the present invention is to provide a cooking utensil and its door lock apparatus, locking method and lock hook position detection method, wherein when the stepper motor assembly drives the locking end of the lock hook to swing, the current change value AI between adjacent time intervals can be used to determine whether the stepper motor assembly is stalled. This eliminates the need for a micro switch in the door lock apparatus of the present invention, thereby simplifying the structure of the door lock apparatus and reducing its cost.

An object of the present invention is to provide a cooking utensil and its door lock apparatus, locking method and lock hook position detection method, wherein when the stepper motor assembly drives the locking end of the lock hook to swing, it can be determined whether the stepper motor assembly is stalled by whether the back electromotive force value when the pulse voltage input to the stepper motor assembly is 0 is 0. This makes the door lock apparatus of the present invention not require the configuration of a micro switch, thereby simplifying the structure of the door lock apparatus and reducing the cost of the door lock apparatus.

According to one aspect of the present invention, the present invention provides a method for detecting the position of a lock hook in a door lock apparatus, wherein the method for detecting the position of the lock hook comprises the following steps:
(I) inputting a pulse voltage to a stepper motor assembly to allow the stepper motor assembly to drive the lock hook to swing with respect to a lock body;
(II) obtaining a back electromotive force value of the stepper motor assembly;
(III) determining whether the back electromotive force is 0 when the pulse voltage is 0, in order to determine whether the stepper motor assembly is stalled; and
(IV) when the stepper motor assembly stalls, confirming that the lock hook has reached a target position.

According to an embodiment of the present invention, in the step (IV) , the lock hook is confirmed to have reached a release target position, a locking target position, or an abnormal target position based on an input method of the pulse voltage of the stepper motor assembly.

According to an embodiment of the present invention, when the stepper motor assembly drives the lock hook to swing from the release target position to the locking target position, the number of pulses input to the stepper motor assembly is calculated, when the stepper motor assembly stalls, the input number of pulses is compared with a preset number of pulses, if the input number of pulses is consistent with the preset number of pulses, it is confirmed that the lock hook has reached the locking target position, if the input number of pulses is greater than the preset number of pulses, it is confirmed that the lock hook has reached the abnormal target position.

According to an embodiment of the present invention, when the current value of the stepper motor assembly is greater than a preset critical current value, it is determined whether the stepper motor assembly is stalled.

According to another aspect of the present invention, the present invention further provides a method for detecting the position of a lock hook in a door lock apparatus, wherein the method for detecting the position of the lock hook comprises the following steps:
(A) inputting a pulse voltage to a stepper motor assembly to allow the stepper motor assembly to drive the lock hook to swing with respect to a lock body;
(B) obtaining a current value of the stepper motor assembly;
(C) determining whether the stepper motor assembly is stalled based on the current change value AI at adjacent time intervals; and
(D) when the stepper motor assembly stalls, confirming that the lock hook has reached a target position.

According to an embodiment of the present invention, in the step (D) , the lock hook is confirmed to have reached a release target position, a locking target position, or an abnormal target position based on an input method of the pulse voltage of the stepper motor assembly.

According to an embodiment of the present invention, when the stepper motor assembly drives the lock hook to swing from the release target position to the locking target position, the number of pulses input to the stepper motor assembly is calculated, when the stepper motor assembly stalls, the input number of pulses is compared with a preset number of pulses, if the input number of pulses is consistent with the preset number of pulses, it is confirmed that the lock hook has reached the locking target position, if the input number of pulses is greater than the preset number of pulses, it is confirmed that the lock hook has reached the abnormal target position.

According to an embodiment of the present invention, when the current value of the stepper motor assembly is greater than a preset critical current value, it is determined whether the stepper motor assembly is stalled.

According to another aspect of the present invention, the present invention further provides a door locking method for a cooking utensil, wherein the door locking method comprises the following steps:
(a) allowing an output shaft of a stepper motor assembly to rotate in one direction so that the stepper motor assembly drives a lock hook to swing with respect to a lock body in one direction;
(b) when the stepper motor assembly stalls, confirming that the lock hook has reached a release target position;
(c) allowing the output shaft of the stepper motor assembly to rotate in the opposite direction so that the stepper motor assembly drives the lock hook to swing with respect to the lock body in the opposite direction;
(d) calculating the number of pulses of the pulse voltage input to the stepper motor assembly; and
(e) comparing the input pulse count with the preset pulse count, wherein if the stepper motor assembly stalls when the input pulse count and the preset pulse count are the same, it is confirmed that the lock hook has reached a locking target position, wherein if the stepper motor assembly does not stall when the input pulse count is greater than the preset pulse count, it is confirmed that the lock hook has reached an abnormal target position.

According to an embodiment of the present invention, in steps (b) and (e), the back electromotive force value of the stepper motor assembly is obtained, and it is determined whether the back electromotive force value is 0 when the pulse voltage is 0, so as to determine whether the stepper motor assembly is stalled.

According to an embodiment of the present invention, in steps (b) and (e), the current value of the stepper motor assembly is obtained, and the stepper motor assembly is determined to be stalled based on the current change value AI at adjacent times.

According to an embodiment of the present invention, in the step (e), when the number of input pulses is greater than a preset number of pulses, the stepper motor assembly is stalled.

According to an embodiment of the present invention, when the current value of the stepper motor assembly is greater than a preset critical current value, it is determined whether the stepper motor assembly is stalled.

According to another aspect of the present invention, the present invention further provides a door lock apparatus, comprising a stepper motor assembly and a lock body assembly, wherein the lock body assembly comprises:
a lock hook having a connecting end and a locking end opposite to the connecting end, wherein the locking end is a hook end;
a lock body comprising a lock plate and a lock wall integrally extended upward from the lock plate, the lock plate has a first blocking protrusion, the lock wall has a hook channel, wherein a middle portion of the lock hook is pivotally disposed in the hook channel of the lock wall;
a sliding transmission element slidably disposed on the lock plate, and a first end of the sliding transmission element is rotatably mounted to the connecting end of the lock hook; and
a rotation transmission element comprising a swing arm on a side thereof, a first position of the rotation transmission element is rotatably mounted to a second end of the sliding transmission element, and a second position of the rotation transmission element is drivably mounted to the output shaft of the stepper motor assembly, the first blocking protrusion of the lock plate is located on a first side of the rotation transmission element, wherein when the stepper motor assembly drives the rotation transmission element to rotate, the rotation transmission element drives the lock hook to swing with respect to the lock body through the sliding transmission element, and the swing arm of the rotation transmission element is allowed to be blocked by the first blocking protrusion of the lock plate.

According to an embodiment of the present invention, the lock plate has a second blocking protrusion located on a second side of the rotation transmission element, wherein when the stepper motor assembly drives the rotation transmission element to rotate, the swing arm of the rotation transmission element is allowed to be blocked by the second blocking protrusion of the lock plate.

According to an embodiment of the present invention, the first blocking protrusion is provided on an upper side of the lock plate, and the rotational transmission element is suspended on an upper side of the lock plate by the stepper motor assembly.

According to an embodiment of the present invention, the first blocking protrusion and the second blocking protrusion are disposed on an upper side of the lock plate, and the rotational transmission element is suspended on an upper side of the lock plate by the stepper motor assembly.

According to an embodiment of the present invention, the lock body comprises at least one mounting arm extended integrally upward from the lock plate, and the stepper motor assembly is mounted on the mounting arm.

According to an embodiment of the present invention, the lock plate has a guide groove, wherein the lock body assembly further comprises a guide element disposed on the sliding transmission element and slidably disposed in the guide groove of the lock plate.

According to an embodiment of the present invention, at least one of the connecting end of the lock hook and one end of the sliding transmission element is rotatably mounted to the guide element.

According to another aspect of the present invention, the present invention further provides a cooking utensil, comprising:
a cooking body having a cooking space and a food passage communicated with the cooking space;
a door having a pivot side, a locking side opposite to the pivot side, and a locking lug located on the locking side, the pivot side of the door is rotatably mounted to the cooking body, and the door is capable of closing the food passage of the cooking body; and
a door lock apparatus which is provided on the cooking body, wherein the door lock apparatus comprises a stepper motor assembly and a lock body assembly, wherein the lock body assembly comprises:
a lock hook having a connecting end and a locking end opposite to the connecting end, wherein the locking end is a hook end;
a lock body comprising a lock plate and a lock wall integrally extended upward from the lock plate, the lock plate has a first blocking protrusion, the lock wall has a hook channel, wherein a middle portion of the lock hook is pivotally disposed in the hook channel of the lock wall;
a sliding transmission element slidably disposed on the lock plate, and a first end of the sliding transmission element is rotatably mounted to the connecting end of the lock hook; and
a rotation transmission element comprising a swing arm on a side thereof, a first position of the rotation transmission element is rotatably mounted to a second end of the sliding transmission element, and a second position of the rotation transmission element is drivably mounted to the output shaft of the stepper motor assembly, the first blocking protrusion of the lock plate is located on a first side of the rotation transmission element, wherein when the stepper motor assembly drives the rotation transmission element to rotate, the rotation transmission element drives the lock hook to swing with respect to the lock body through the sliding transmission element, and the swing arm of the rotation transmission element is allowed to be blocked by the first blocking protrusion of the lock plate, wherein the lock hook of the door lock apparatus is configured to release or hook the locking lug of the door.

According to another aspect of the present invention, the present invention further provides a door lock apparatus comprising a stepper motor assembly and a lock body assembly, wherein the lock body assembly comprises:
a lock hook having a connecting end and a locking end opposite to the connecting end, wherein the locking end is a hook end;
a lock body comprising a lock plate and a lock wall integrally extended upward from the lock plate, the lock plate has an arcuate groove, the lock wall has a hook channel, wherein a middle portion of the lock hook is pivotally disposed in the hook channel of the lock wall;
a sliding transmission element which is slidably disposed on the lock plate, and a first end of the sliding transmission element is rotatably mounted to the connecting end of the lock hook; and
a rotation transmission element, wherein a bottom side of the rotation transmission element is provided with a limiting protrusion, a first position of the rotation transmission element is rotatably mounted to a second of the sliding transmission element, and a second position is drivably mounted to the output shaft of the stepper motor assembly, the limiting protrusion of the rotation transmission element is slidably disposed in the arcuate groove of the lock plate, wherein when the stepper motor assembly drives the rotation transmission element to rotate, the rotation transmission element drives the lock hook to swing with respect to the lock body through the sliding transmission element, and the limiting protrusion of the rotation transmission element can be blocked by the inner wall of the lock plate for forming the arcuate groove.

According to an embodiment of the present invention, the rotational transmission element is suspended above the lock plate by the stepper motor assembly.

According to an embodiment of the present invention, the lock body comprises at least one mounting arm extended integrally upward from the lock plate, and the stepper motor assembly is mounted on the mounting arm.

According to an embodiment of the present invention, the lock plate has a guide groove, wherein the lock body assembly further comprises a guide element disposed on the sliding transmission element and slidably disposed in the guide groove of the lock plate.

According to an embodiment of the present invention, at least one of the connecting end of the lock hook and one end of the sliding transmission element is rotatably mounted to the guide element.

According to another aspect of the present invention, the present invention further provides a cooking utensil, comprising:
a cooking body having a cooking space and a food passage communicated with the cooking space;
a door having a pivot side, a locking side opposite to the pivot side, and a locking lug located on the locking side, the pivot side of the door is rotatably mounted to the cooking body, and the door is capable of closing the food passage of the cooking body; and
a door lock apparatus which is provided on the cooking body, wherein the door lock apparatus comprises a stepper motor assembly and a lock body assembly, wherein the lock body assembly comprises:
a lock hook having a connecting end and a locking end opposite to the connecting end, wherein the locking end is a hook end;
a lock body comprising a lock plate and a lock wall integrally extended upward from the lock plate, the lock plate has a first blocking protrusion, the lock wall has a hook channel, wherein a middle portion of the lock hook is pivotally disposed in the hook channel of the lock wall;
a sliding transmission element slidably disposed on the lock plate, and a first end of the sliding transmission element is rotatably mounted to the connecting end of the lock hook; and
a rotation transmission element comprising a swing arm on a side thereof, a first position of the rotation transmission element is rotatably mounted to a second end of the sliding transmission element, and a second position of the rotation transmission element is drivably mounted to the output shaft of the stepper motor assembly, the first blocking protrusion of the lock plate is located on a first side of the rotation transmission element, wherein when the stepper motor assembly drives the rotation transmission element to rotate, the rotation transmission element drives the lock hook to swing with respect to the lock body through the sliding transmission element, and the swing arm of the rotation transmission element is allowed to be blocked by the first blocking protrusion of the lock plate, wherein the lock hook of the door lock apparatus is configured to release or hook the locking lug of the door.

### BRIEF DESCRIPTION OF THE DRAWINGS

FIG. 1 is a perspective view of a conventional door lock.

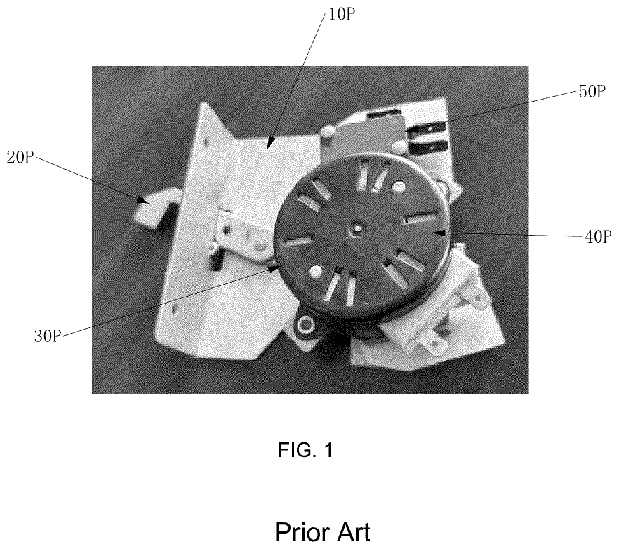

FIG. 2 is a perspective view of a cooking utensil in a state according to a preferred embodiment of the present invention.

FIG. 3 is a perspective view of another state of the cooking utensil according to the above-described preferred embodiment of the present invention.

FIG. 4 is a cross-sectional schematic view of the cooking utensil according to the above-described preferred embodiment of the present invention.

FIG. 5 is a partially enlarged view of a location in FIG. 4.

FIG. 6 is another perspective view of the cooking utensil according to the above-described preferred embodiment of the present invention.

FIG. 7 is a partially enlarged view of a location in FIG. 6.

FIG. 8 is a perspective view of a door lock apparatus of the cooking utensil according to the above-described preferred embodiment of the present invention.

FIG. 9 is a perspective view of the door lock apparatus of the cooking utensil according to the above-described preferred embodiment of the present invention.

FIG. 10 is an exploded view of the door lock apparatus of the cooking utensil according to the above-described preferred embodiment of the present invention.

FIG. 11 is an exploded view of the door lock apparatus of the cooking utensil according to the above-described preferred embodiment of the present invention.

FIG. 12 is a perspective view of a partial structure of the door lock apparatus of the cooking utensil according to the above-described preferred embodiment of the present invention.

FIG. 13 is a perspective view of a partial structure of the door lock apparatus of the cooking utensil according to the above-described preferred embodiment of the present invention.

FIG. 14 is an exploded schematic view from one perspective of the partial structure of the door lock apparatus of the cooking utensil according to the above-described preferred embodiment of the present invention.

FIG. 15 is an exploded schematic view from another perspective of the partial structure of the door lock apparatus of the cooking utensil according to the above-described preferred embodiment of the present invention.

FIGS. 16 and 17 show the state of the door lock apparatus of the cooking utensil according to the above-described preferred embodiment of the present invention when the lock hook reaches a release target position.

FIGS. 18A and 18B show the states of the door lock apparatus of the cooking utensil according to the above-described preferred embodiment of the present invention when the lock hook reaches a locking target position. FIGS. 19A, 19B, and 19C are schematic views illustrating three intermediate states during the switching of the lock hook from the release target position shown in FIGS. 16 and 17 to the locking target position shown in FIGS. 18A and 18B.

FIGS. 20 and 21 show the states of the door lock apparatus of the cooking utensil according to the above-described preferred embodiment of the present invention when the lock hook reaches an abnormal target position.

FIG. 22 is an exploded view of an alternative door lock apparatus of the cooking utensil according to the above-described preferred embodiment of the present invention.

FIG. 23 is an exploded view of the alternative door lock apparatus of the cooking utensil according to the above-described preferred embodiment of the present invention.

FIGS. 24 and 25 show the state of the door lock apparatus of the cooking utensil according to the above-described preferred embodiment of the present invention when the lock hook reaches a release target position.

FIGS. 26 and 27 show the state of the door lock apparatus of the cooking utensil according to the above-described preferred embodiment of the present invention when the lock hook reaches a locking target position.

### DETAILED DESCRIPTION OF THE PREFERRED EMBODIMENT

Before detailing any embodiment of the invention, it should be understood that the invention, in its application, is not limited to the details of the construction and arrangement of the components set forth in the following description or illustrated in the following figures. The invention can have other embodiments and can be practiced or carried out in various ways. Furthermore, it should be understood that the wording and terminology used herein are for descriptive purposes and should not be considered limiting. The use of “comprising” or “having” and variations thereof is intended to cover the items set forth below and their equivalents, as well as any additional items. Unless otherwise specified or limited, the terms “installation”, “connection”, “support”, and “linkage”, and variations thereof are used broadly and cover both direct and indirect installation, connection, support, and linking. Moreover, “connect” and “link” are not limited to physical or mechanical connections or links.

Furthermore, firstly, in the disclosure of the present invention, the terms “longitudinal”, “lateral”, “upper”, “lower”, “front”, “rear”, “left”, “right”, “vertical”, “horizontal”, “top”, “bottom”, “inner”, and “outer”, etc., indicate the orientation or positional relationship based on the orientation or positional relationship shown in the accompanying drawings. They are only for the convenience of describing the present invention and simplifying the description, and do not indicate or imply that the device or element referred to must have a specific orientation, or be constructed and operated in a specific orientation. Therefore, the above terms should not be construed as limiting the invention. Secondly, the term “a” or “an” should be understood as “at least one” or “one or more”, that is, in one embodiment, the number of an element can be one, while in another embodiment, the number of the element can be multiple. The term “a” or “an” should not be construed as a limitation on the quantity.

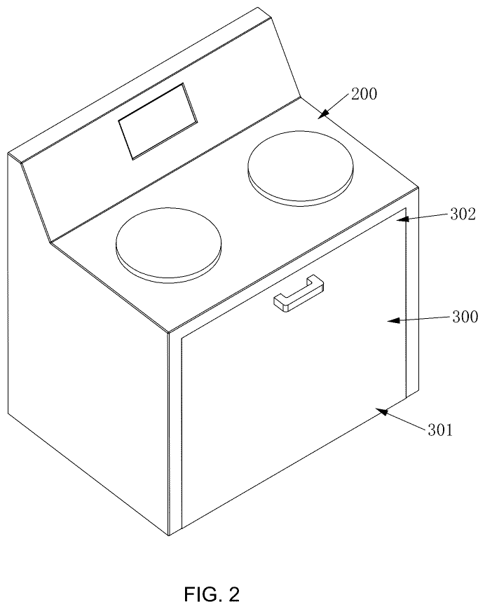

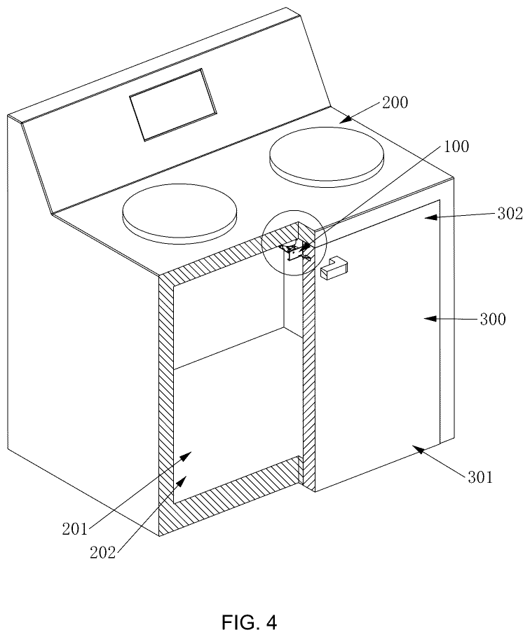

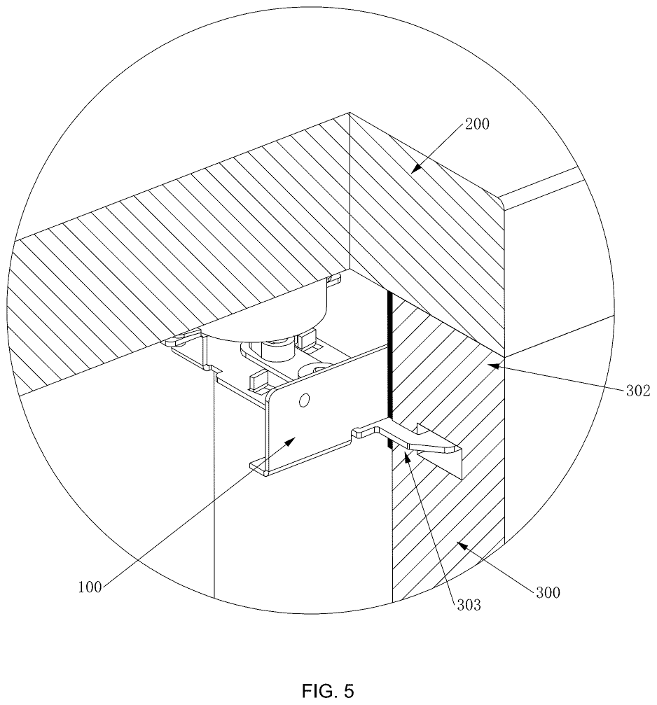

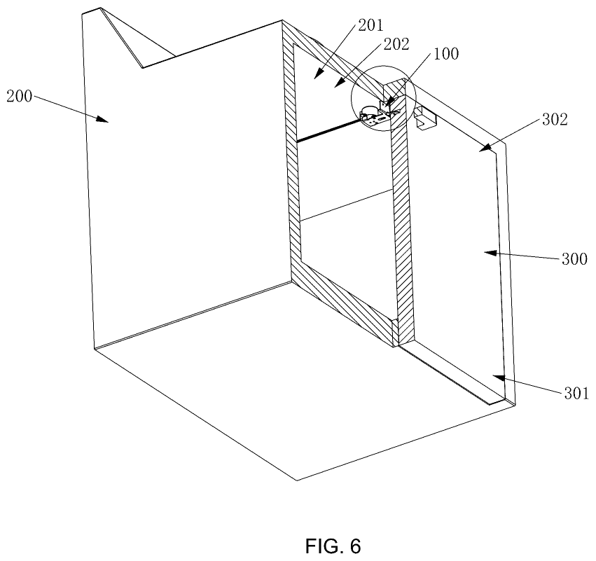

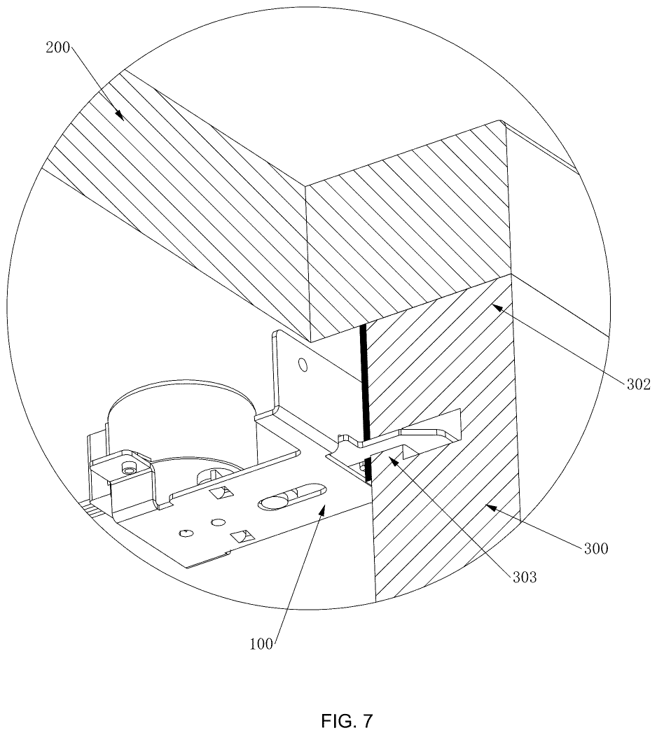

FIGS. 2 to 7 illustrate a cooking utensil according to a preferred embodiment of the present invention, wherein the cooking utensil comprises a door lock apparatus 100, a cooking body 200, and a door 300, wherein the cooking body 200 has a cooking space 201 and a food passage 202 communicated with the cooking space 201, wherein the door 300 has a pivot side 301, a locking side 302 opposite to the pivot side 301, and a locking lug 303 located on the locking side 302, wherein the pivot side 301 of the door 300 is rotatably mounted to the cooking body 200, and the door 300 is capable of closing the food passage 202 of the cooking body 200, wherein the door lock apparatus 100 is disposed in the cooking body 200, and the door lock apparatus 100 is configured to hook or release the locking lug 303 of the door 300. When the door lock apparatus 100 retains the locking lug 303 of the door 300, the cooking utensil prevents the user from opening the door 300; correspondingly, when the door lock apparatus 100 releases the locking lug 303 of the door 300, the cooking utensil allows the user to open the door 300. Optionally, in other examples of the cooking utensil of the invention, the door lock apparatus 100 may be disposed on the door 300, and correspondingly, the locking lug 303 may be disposed on the cooking body 200.

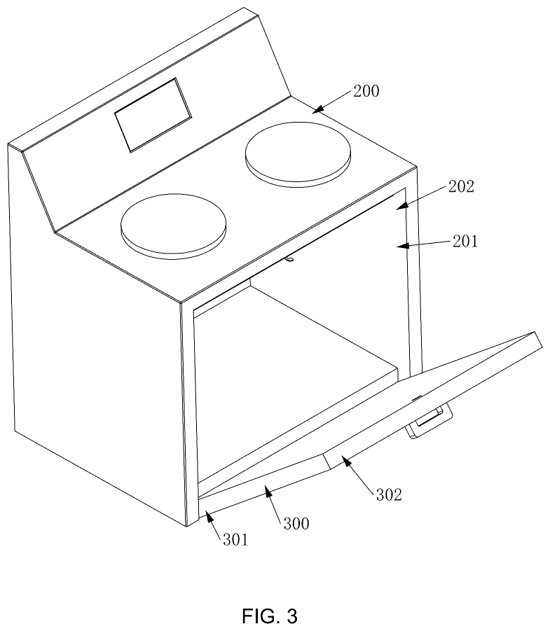

It is understood that, referring to FIGS. 2 and 3, when the door 300 of the cooking utensil is opened, the food passage 202 of the cooking body 200 is exposed. At this time, food can be placed into the cooking space 201 of the cooking body 200 through the food passage 202, or food can be taken out of the cooking space 201 of the cooking body 200 through the food passage 202. Correspondingly, when the door 300 of the cooking utensil is closed, the food passage 202 of the cooking body 200 is closed. At this time, food is not allowed to be placed into the cooking space 201 of the cooking body 200 through the food passage 202, or food is not allowed to be taken out of the cooking space 201 of the cooking body 200 through the food passage 202. When the door lock apparatus 100 hooks the locking lug 303 of the door 300, the door 300 is in a position that closes the food passage 202 of the cooking body 200, and the door lock apparatus 100 prevents the door 300 from being opened by being pulled by the user.

It is worth mentioning that the specific type of cooking utensil is not limited in this invention; for example, the cooking utensil may be an oven.

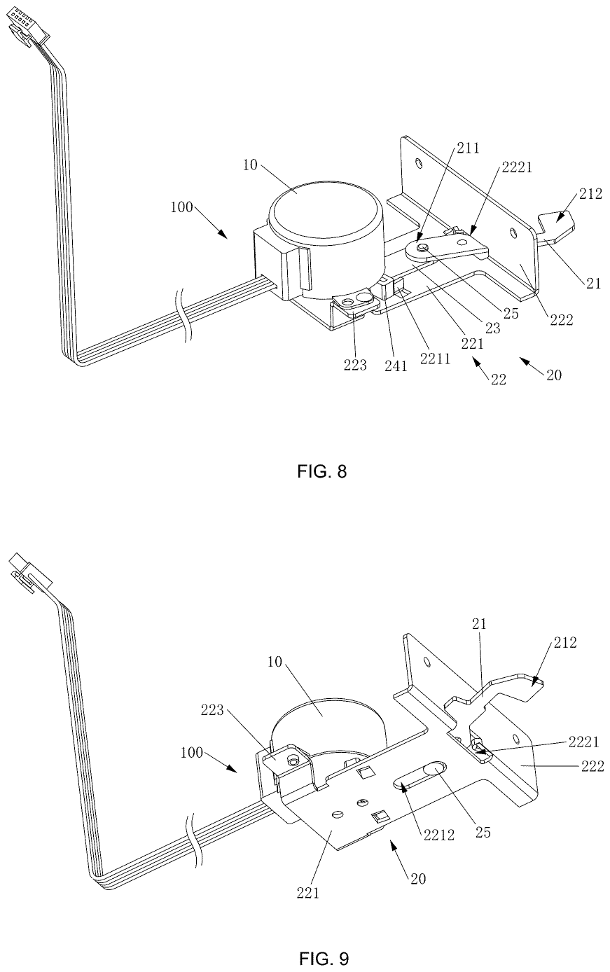

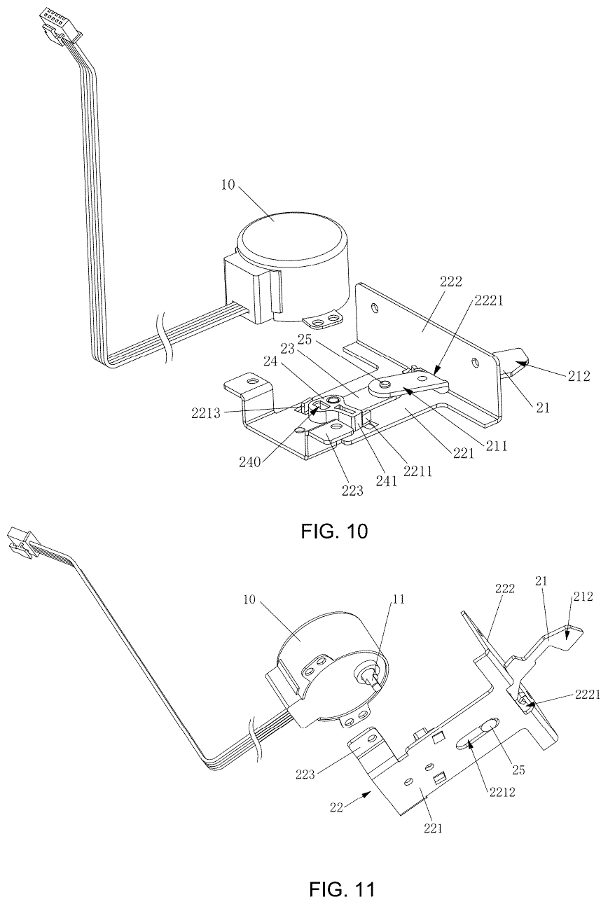

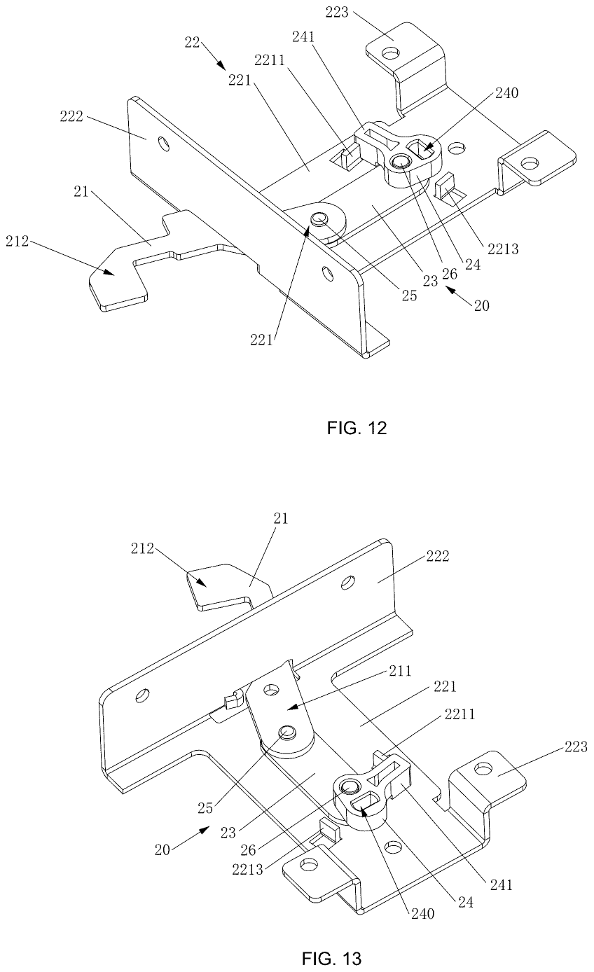

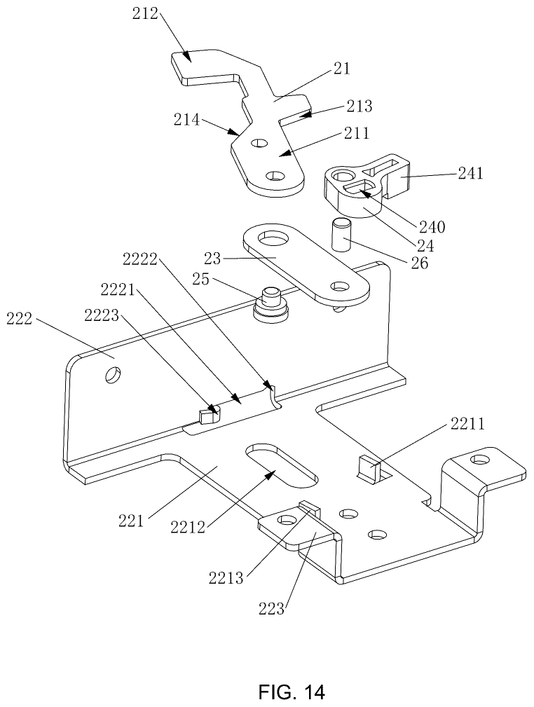

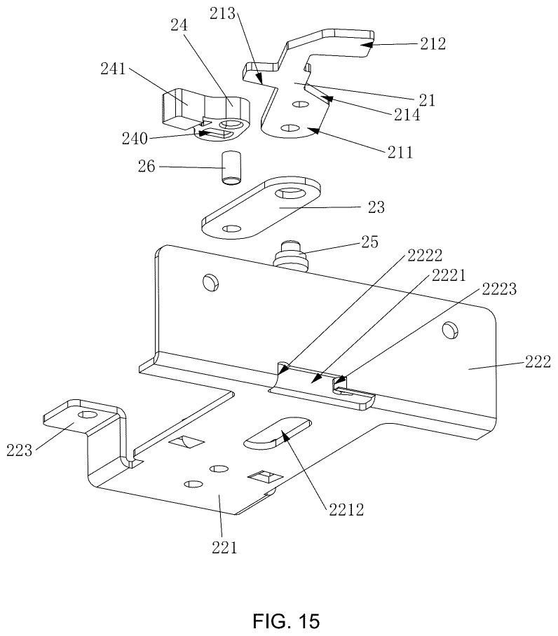

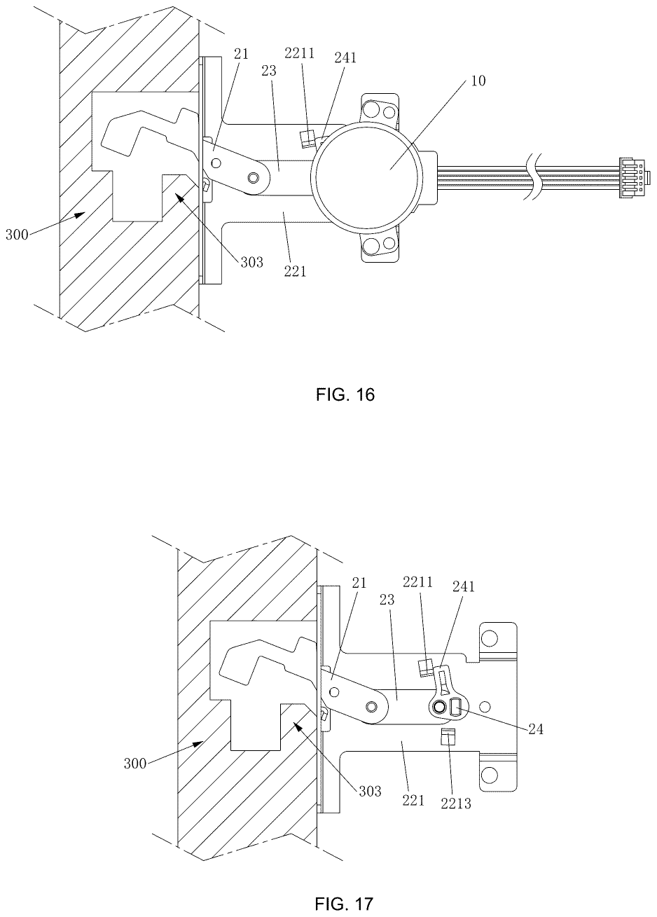

Turning now to FIGS. 8 to 21, which illustrate a specific embodiment of the door lock apparatus 100, wherein the door lock apparatus 100 comprises a stepper motor assembly 10 and a lock body assembly 20.

The stepper motor assembly 10 has an output shaft 11. When a pulse voltage is input to the stepper motor assembly 10, the stepper motor assembly 10 outputs power by rotating the output shaft 11. Unlike conventional door locks that use synchronous motors as power sources, the stepper motor assembly 10 of the door lock apparatus 100 of the present invention can be input with low-voltage direct current. This eliminates the safety hazard to users caused by leakage current in the door lock apparatus 100 of the present invention. It is understood that the input method of the pulse voltage determines the rotation direction of the output shaft 11 of the stepper motor assembly 10. For example, the output shaft 11 of the stepper motor assembly 10 can rotate clockwise or counterclockwise.

In some embodiments of the present invention, the stepper motor assembly 10 is implemented as a stepper motor, the rotor of which is the output shaft 11 of the stepper motor assembly 10. It is understood that this stepper motor is a motor whose rotor is driven to rotate by pulse voltage. Each time a pulse voltage is input to the coil of the stepper motor, the rotor of the stepper motor rotates by a certain angle. For example, the step angle of the stepper motor can be 15°, so that each time a pulse voltage is input to the coil of the stepper motor, the rotor of the stepper motor rotates 15°, that is, the output shaft 11 of the stepper motor assembly 10 rotates 15°. Therefore, in the door lock apparatus 100 of the present invention, the rotation angle of the output shaft 11 can be controlled by controlling the number of pulses of the pulse voltage input to the stepper motor assembly 10.

In other embodiments of the invention, the stepper motor assembly 10 is implemented as a combination of a stepper motor and a gearbox, with the output shaft 11 of the stepper motor assembly 10 formed by the gearbox. The rotation angle of the output shaft 11 of the stepper motor assembly 10 is related to the step angle of the stepper motor and the reduction ratio of the gearbox each time a pulse voltage is input to the coil of the stepper motor. For example, if the step angle of the stepper motor is 15° and the reduction ratio of the gearbox is 150, then the output shaft 11 of the stepper motor assembly 10 rotates by 0.1° each time a pulse voltage is input to the coil of the stepper motor. That is, to rotate the output shaft 11 of the stepper motor assembly 10 by 360°, 3600 pulse voltages are required to be supplied to the coil of the stepper motor. Therefore, in the door lock apparatus 100 of the invention, the rotation angle of the output shaft 11 can be controlled by controlling the number of pulses of the pulse voltage input to the stepper motor assembly 10.

It is worth mentioning that the position of the output shaft 11 of the stepper motor assembly 10 is not limited in the door lock apparatus 100 of the present invention. For example, in some embodiments of the present invention, the output shaft 11 of the stepper motor assembly 10 is located on the central axis of the stepper motor assembly 100. In other embodiments of the present invention, the output shaft 11 of the stepper motor assembly 10 is offset from the central axis of the stepper motor assembly 100, that is, the stepper motor assembly 100 has an eccentric output shaft 11.

Continue to refer to FIGS. 8 to 21, the lock body assembly 20 comprises a lock hook 21, a lock body 22, a sliding transmission element 23, and a rotation transmission element 24. The lock hook 21 has a connecting end 211 and a hook-shaped locking end 212 opposite to the connecting end 211. The lock body 22 comprises a lock plate 221 and a lock wall 222 integrally extending upward from the lock plate 221. The lock wall 222 has a hook channel 2221. The middle part of the lock hook 21 is pivotally disposed in the hook channel 2221 of the lock wall 222. The sliding transmission element 23 is slidably disposed on the lock plate 221. One end of the sliding transmission element 23 is rotatably mounted to the connecting end 211 of the lock hook 21, and the other end of the sliding transmission element 23 is rotatably mounted to a position of the rotation transmission element 24. A position of the rotation transmission element 24 is drivably mounted to the output shaft 11 of the stepper motor assembly 10. When the stepper motor assembly 10 is input with a pulse voltage and outputs power by rotating the output shaft 11, the stepper motor assembly 10 drives the rotational transmission element 24 to rotate. When the rotational transmission element 24 rotates, it pulls or pushes the sliding transmission element 23 to produce a displacement with respect to the lock plate 221. With the assistance of the lock wall 222, the locking end 212 of the lock hook 21 swings with respect to the lock body 22 to release or hook the locking lug 303 of the door 300.

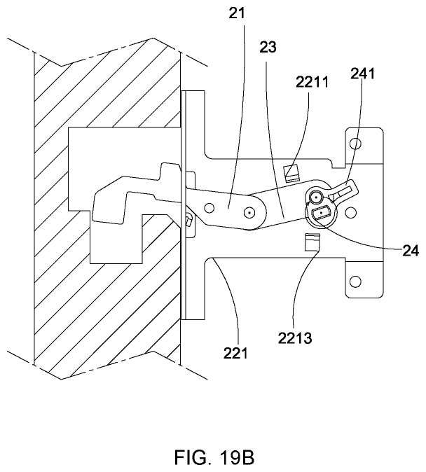

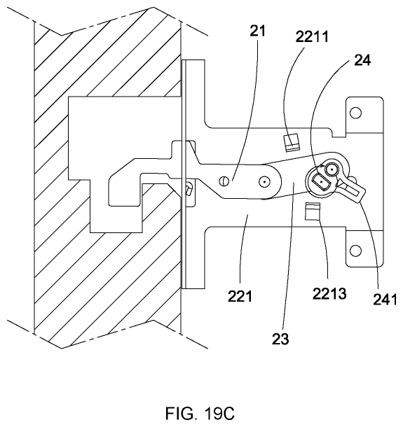

The rotation transmission element 24 has a swing arm 241 on one side, and the lock plate 221 of the lock body 22 has a first blocking protrusion 2211. The first blocking protrusion 2211 is located on one side of the rotation transmission element 24. When the stepper motor assembly 10 drives the lock hook 21 to swing upward with respect to the lock body 22 through the rotation transmission element 24 and the sliding transmission element 23, referring to FIGS. 16 and 17, the first blocking protrusion 2211 of the lock plate 221 can block the swing arm 241 of the rotation transmission element 24, so as to block the stepper motor assembly 10. At this time, the position of the lock hook 21 is defined as a release target position. When the door 300 is in the release target position, the lock hook 21 releases the locking lug 303 of the door 300 to allow the door 300 to be opened. When the stepper motor assembly 10 drives the lock hook 21 to swing downwards with respect to the lock body 22 via the rotational transmission element 24 and the sliding transmission element 23, referring to FIGS. 18A to 19C, the locking lug 303 of the door 300 can block the locking end 212 of the lock hook 21, causing the stepper motor assembly 10 to stall. At this time, the position of the lock hook 21 is defined as a locking target position. When the lock hook 21 is in the locking target position, it hooks the locking lug 303 of the door 300 to prevent the door 300 from being opened.

It is understood that when the stepper motor assembly 10 stalls, the current change value ΔI of the stepper motor assembly 10 in adjacent time intervals increases sharply. Therefore, during the process where the stepper motor assembly 10 drives the lock hook 21 to swing with respect to the lock body 22 through the rotational transmission element 24 and the sliding transmission element 23, by real-time detection of the current value of the stepper motor assembly 10 and determining whether the current change value ΔI in adjacent time intervals increases sharply, it can be confirmed whether the lock hook 21 has swung to a target position. In this way, the door lock apparatus 100 of the present invention does not need to be equipped with a micro switch, which helps to simplify the structure of the door lock apparatus 100 and reduce the cost of the door lock apparatus 100, while improving the reliability of the door lock apparatus 100. Preferably, when the current value of the stepper motor assembly 10 is greater than a preset critical current value, it is determined whether the stepper motor assembly 10 is stalled. In this way, accurate judgment of the safe operating state of the stepper motor assembly 10 can be ensured.

It is worth mentioning that before the stepper motor assembly 10 stalls, the current I in the coil of the stepper motor assembly 10 is stable and its value is in a light load state (the current value I is small). Therefore, the current change value ΔI~0 within the time interval Δt, that is, the current values corresponding to the two small change time points are very close. When the stepper motor assembly 10 stalls, the current I in the coil of the stepper motor assembly 10 suddenly increases rapidly, causing the current change value ΔI to increase sharply. Therefore, it can be determined whether the lock hook 21 has swung to the target position by judging whether the current change value ΔI in adjacent time intervals increases sharply.

It is also worth mentioning that the target position can be either the release target position or the locking target position. In the door lock apparatus 100 of the present invention, when the stepper motor assembly 10 is stalled, the lock hook 21 can be confirmed as being in the release target position or the locking target position based on the input method of the pulse voltage of the stepper motor assembly 10. Specifically, when the stepper motor assembly 10 drives the lock hook 21 to swing upward with respect to the lock body 22 via the rotation transmission element 24 and the sliding transmission element 23, referring to FIGS. 16 and 17, if the stepper motor assembly 10 is blocked by the first blocking protrusion 2211 of the lock plate 221 blocking the swing arm 241 of the rotation transmission element 24, then the lock hook 21 is confirmed to be in the release target position. At this time, the lock hook 21 releases the locking lug 303 of the door 300 to allow the door 300 to be opened. Correspondingly, when the stepper motor assembly 10 drives the lock hook 21 to swing downward with respect to the lock body 22 via the rotation transmission element 24 and the sliding transmission element 23, referring to FIGS. 18A to 19C, if the stepper motor assembly 10 is blocked because the locking lug 303 of the door 300 blocks the locking end 212 of the lock hook 21, then the lock hook 21 is confirmed to be in the locking target position. At this time, the lock hook 21 hooks the locking lug 303 of the door 300 to prevent the door 300 from being opened.

Specifically, referring to FIGS. 16 to 19C, when the output shaft 11 of the stepper motor assembly 10 rotates counterclockwise, the stepper motor assembly 10 drives the lock hook 21 to swing upward with respect to the lock body 22 through the rotation transmission element 24 and the sliding transmission element 23. If the stepper motor assembly 10 stalls at this time, it is confirmed that the lock hook 21 has reached the release target position. When the output shaft 11 of the stepper motor assembly 10 rotates counterclockwise, the stepper motor assembly 10 drives the lock hook 21 to swing downward with respect to the lock body 22 through the rotation transmission element 24 and the sliding transmission element 23. If the stepper motor assembly 10 stalls at this time, it is confirmed that the lock hook 21 has reached the locking target position.

Furthermore, during the process where the stepper motor assembly 10 drives the lock hook 21 to swing with respect to the lock body 22 via the rotational transmission element 24 and the sliding transmission element 23, by real-time detection of the back electromotive force value of the stepper motor assembly 10 and determining whether the back electromotive force value is 0 when the pulse voltage is 0, it can be confirmed whether the lock hook 21 has swung to the target position. In this way, the door lock apparatus 100 of the present invention does not need to be configured with a micro switch, which helps to simplify the structure of the door lock apparatus 100 and reduce the cost of the door lock apparatus 100, while improving the reliability of the door lock apparatus 100. Specifically, in the door lock apparatus 100 of the present invention, when the stepper motor assembly 10 is stalled, it can be confirmed whether the lock hook 21 is in the release target position or the locking target position based on the input method of the pulse voltage of the stepper motor assembly 10. Specifically, when the stepper motor assembly 10 drives the lock hook 21 to swing upward with respect to the lock body 22 via the rotation transmission element 24 and the sliding transmission element 23, referring to FIGS. 16 and 17, if the stepper motor assembly 10 is blocked by the first blocking protrusion 2211 of the lock plate 221 blocking the swing arm 241 of the rotation transmission element 24, then the lock hook 21 is confirmed to be in the release target position. At this time, the lock hook 21 releases the locking lug 303 of the door 300 to allow the door 300 to be opened. Correspondingly, when the stepper motor assembly 10 drives the lock hook 21 to swing downward with respect to the lock body 22 via the rotation transmission element 24 and the sliding transmission element 23, referring to FIGS. 18A to 19C, if the stepper motor assembly 10 is blocked because the locking lug 303 of the door 300 blocks the locking end 212 of the lock hook 21, then the lock hook 21 is confirmed to be in the locking target position. At this time, the lock hook 21 hooks the locking lug 303 of the door 300 to prevent the door 300 from being opened.

It is worth noting that the manner in which the sliding transmission element 23 is rotatably mounted to the rotation transmission element 24 is not limited in the door lock apparatus 100 of the present invention. For example, the lock body assembly 20 comprises a mounting shaft 25, to which at least one of the sliding transmission element 23 and the rotation transmission element 24 is rotatably mounted, thereby such that the sliding transmission element 23 is rotatably mounted to the rotation transmission element 24.

It is also worth mentioning that the manner in which the rotation transmission element 24 is drivably mounted to the output shaft 11 of the stepper motor assembly 10 is not limited in the door lock apparatus 100 of the present invention. For example, the rotation transmission element 24 has a non-circular insertion hole 240, the shape and size of the output shaft 11 of the stepper motor assembly 10 matching the size and shape of the insertion hole 240 of the rotation transmission element 24, wherein the end of the output shaft 11 of the stepper motor assembly 10 is inserted into the insertion hole 240 of the rotation transmission element 24, so that the rotation transmission element 24 is drivably mounted to the output shaft 11 of the stepper motor assembly 10.

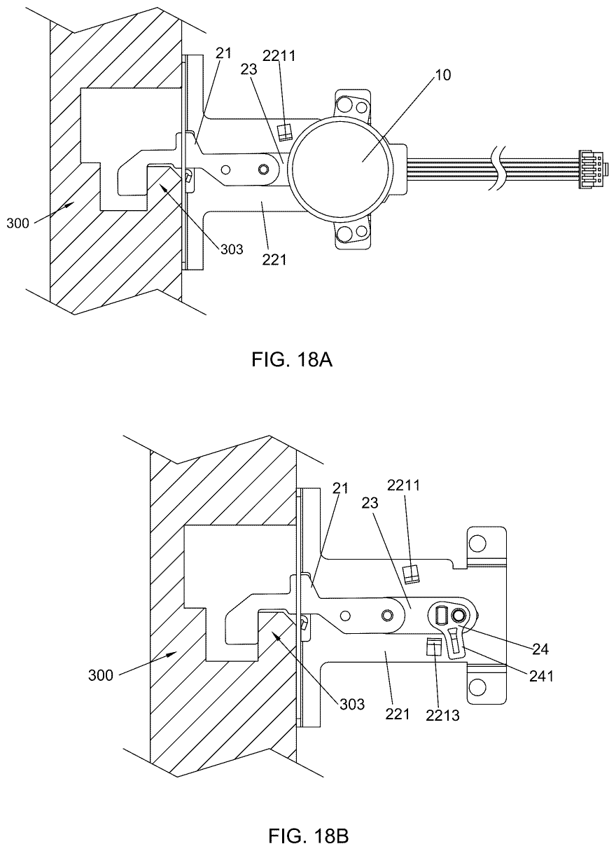

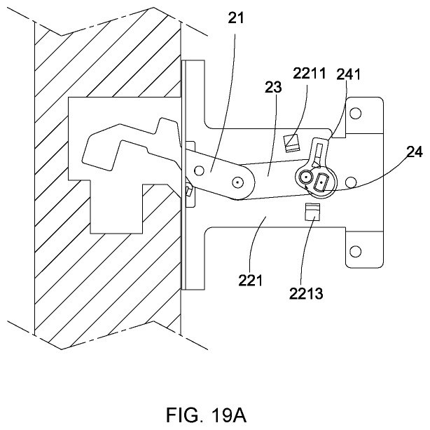

Referring again to FIGS. 14 and 15, the lock body assembly 20 further comprises a guide element 26 disposed on the sliding transmission element 23. The lock plate 221 has a guide groove 2212, and the guide element 26 is slidably disposed in the guide groove 2212 of the lock plate 221. When the stepper motor assembly 10 drives the rotation transmission element 24 to rotate, the guide element 26 and the lock plate 221 cooperate to cause the sliding transmission element 23 to slide with respect to the lock plate 221. In other words, the guide element 26 and the lock plate 221 cooperate to convert the rotation of the rotation transmission element 24 into the sliding of the sliding transmission element 23. Optionally, in other examples of the door lock apparatus 100 of the present invention, the guide element 26 may be provided on the lock plate 221, and the guide groove 2212 may be provided on the sliding transmission element 23, so that the guide element 26 and the lock plate 221 cooperate to convert the rotation of the rotational transmission element 24 into the sliding of the sliding transmission element 23.

It is worth mentioning that the specific manner in which the guide element 26 is disposed on the sliding transmission element 23 is not limited in the door lock apparatus 100 of the present invention. For example, in this specific example of the door lock apparatus 100 of the present invention shown in FIGS. 8 to 21, the connecting end 211 of the lock hook 21 and one end of the sliding transmission element 23 are both mounted on the guide element 26 to provide the guide element 26 to the sliding transmission element 23, and at least one of the connecting end 211 of the lock hook 21 and the end of the sliding transmission element 23 is rotatably mounted on the guide element 26, so that when the sliding transmission element 23 is driven by the rotational transmission element 24 to produce a sliding with respect to the lock plate 221, the locking end 212 of the lock hook 21 produces a swing with respect to the lock body 22.

Referring again to FIGS. 8 to 21, the lock hook 21 has a first guide slope 213 and a second guide slope 214 opposite to the first guide slope 213. The extension direction of the first guide slope 213 of the lock hook 21 and the sliding direction of the sliding transmission element 23 have an obtuse angle, and the extension direction of the second guide slope 214 of the lock hook 21 and the sliding direction of the sliding transmission element 23 have an acute angle. The locking wall 222 has a first abutting side 2222 and a second abutting side 2223. The first abutting side 2222 and the second abutting side 2223 are a pair of opposite sides of the locking wall 222 for defining the hook channel 2221. The first guide slope 213 of the lock hook 21 can abut against the first abutting side 2222 of the locking wall 222, and the second guide slope 214 of the lock hook 21 can abut against the second abutting side 2223 of the locking wall 222.

When the stepper motor assembly 10 is input with a pulse voltage and outputs power by rotating the output shaft 11 clockwise, the stepper motor assembly 10 drives the rotational transmission element 24 to rotate around the output shaft 11. The rotational transmission element 24 pulls the sliding transmission element 23 inward, causing the sliding transmission element 23 to slide with respect to the lock plate 221 of the lock body 22. At this time, the sliding transmission element 23 pulls the connecting end 211 of the lock hook 21 inward. Since the first guide slope 213 of the lock hook 21 abuts against the first abutting side 2222 of the lock wall 222, the locking end 212 of the lock hook 21 swings with respect to the lock wall 222 of the lock body 22, so that the lock hook 21 reaches the locking target position and the locking end 212 of the lock hook 21 can hook the locking lug 303 of the door 300.

Correspondingly, when the stepper motor assembly 10 is input with a pulse voltage and outputs power by rotating the output shaft 11 counterclockwise, the stepper motor assembly 10 drives the rotational transmission element 24 to rotate around the output shaft 11. The rotational transmission element 24 pushes the sliding transmission element 23 inward and outward, so that the sliding transmission element 23 slides with respect to the lock plate 221 of the lock body 22. At this time, the sliding transmission element 23 pushes the connecting end 211 of the lock hook 21 outward. Since the second guide slope 214 of the lock hook 21 abuts against the second abutting side 2223 of the lock wall 222, the locking end 212 of the lock hook 21 can swing with respect to the lock wall 222 of the lock body 22, so that the lock hook 21 reaches the release target position and the locking end 212 of the lock hook 21 can release the locking lug 303 of the door 300.

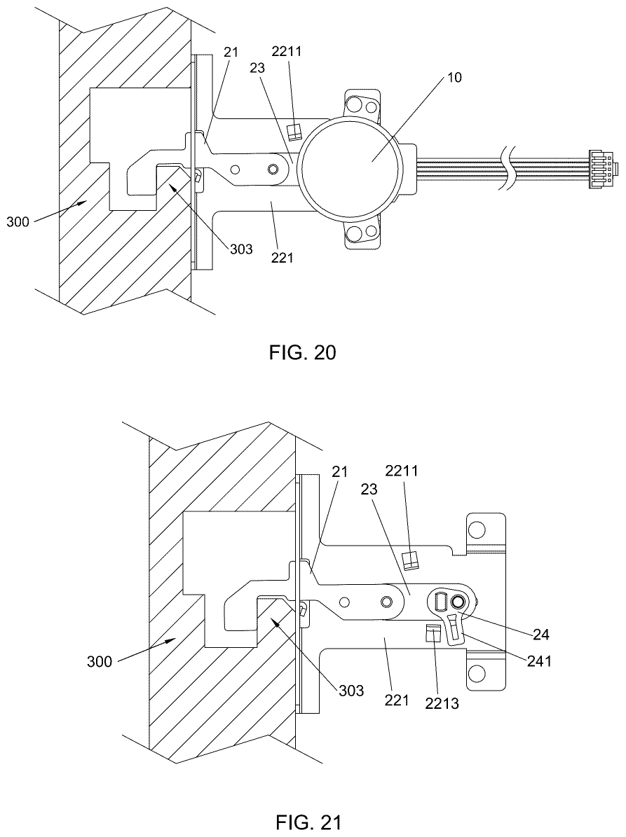

Furthermore, the lock plate 221 of the lock body 22 has a second blocking protrusion 2213. The first blocking protrusion 2211 and the second blocking protrusion 2213 are respectively located on opposite sides of the rotation transmission element 24. When the stepper motor assembly 10 is input with a pulse voltage and outputs power by rotating counterclockwise with the output shaft 11, the swing arm 241 of the rotation transmission element 24 can be blocked by the first blocking protrusion 2211 of the lock plate 221, so that the stepper motor assembly 10 is stalled. At this time, the lock hook 21 reaches the release target position. Correspondingly, when the stepper motor assembly 10 is input with a pulse voltage and outputs power by rotating clockwise with the output shaft 11, if the locking end 212 of the lock hook 21 does not hook the locking lug 303 of the door 300, the swing arm 241 of the rotation transmission element 24 can be blocked by the lock plate 221. The second blocking protrusion 2213 of the lock plate 221 blocks the stepper motor assembly 10, causing it to stall. At this time, the lock hook 21 reaches an abnormal target position, as shown in FIGS. 20 and 21. It is understood that when the lock hook 21 reaches the abnormal target position, the door lock apparatus 100 has not locked the door 300 onto the cooking body 200. If the cooking utensil is started at this time, it will pose a significant safety hazard to the user. In this situation, the cooking utensil can remind the user to check whether the door 300 of the cooking utensil is properly closed.

In other words, referring to FIGS. 16 and 17, when the stepper motor assembly 10 drives the lock hook 21 to swing upward with respect to the lock body 22 via the rotation transmission element 24 and the sliding transmission element 23, the first blocking protrusion 2211 of the lock plate 221 can block the swing arm 241 of the rotation transmission element 24, causing the stepper motor assembly 10 to stall, at which point the lock hook 21 reaches the release target position. Referring to FIGS. 18A to 19C, when the stepper motor assembly 10 drives the lock hook 21 to swing downward with respect to the lock body 22 via the rotation transmission element 24 and the sliding transmission element 23, the locking end 212 of the lock hook 21 can hook the locking lug 303 of the door 300, causing the stepper motor assembly 10 to stall, at which point the lock hook 21 reaches the locking target position. Referring to FIGS. 20 and 21, when the stepper motor assembly 10 drives the lock hook 21 to swing downward with respect to the lock body 22 through the rotational transmission element 24 and the sliding transmission element 23, if the door 300 is not closed, the second blocking protrusion 2213 of the lock plate 221 can block the swing arm 241 of the rotational transmission element 24, thereby causing the stepper motor assembly 10 to stall. At this time, the lock hook 21 reaches the abnormal target position.

When the stepper motor assembly 10 outputs power by rotating the output shaft 11 clockwise when a pulse voltage is input, in order to confirm whether the target position reached by the lock hook 21 is the locking target position or the abnormal target position, when the stepper motor assembly 10 is stalled, the number of input pulses is compared with a preset number of pulses. If the number of input pulses is the same as the preset number of pulses, it is confirmed that the lock hook 21 has reached the locking target position. If the number of input pulses is greater than the preset number of pulses, it is confirmed that the lock hook 21 has reached the abnormal target position.

For example, in a specific example of the cooking utensil of the present invention, if the lock hook 21 swings from the release target position to the locking target position and requires the output shaft 11 of the stepper motor assembly 10 to rotate 180°, then a pulse voltage of 1800 pulses needs to be provided to the stepper motor assembly 10, that is, the preset pulse number is 1800. When the stepper motor assembly 10 outputs power by rotating clockwise on the output shaft 11 in response to an input pulse voltage, the number of pulses of the input pulse voltage to the stepper motor assembly 10 can be calculated. If the stepper motor assembly 10 stalls when the number of pulses of the input pulse voltage is around 1800 (e.g., 1800±5), the number of input pulses is consistent with the preset number of pulses, and at this time, it is confirmed that the lock hook 21 has reached the locking target position. If the stepper motor assembly 10 stalls when the number of pulses of the input pulse voltage is around 2000, the number of input pulses is greater than the preset number of pulses, and at this time, it is confirmed that the lock hook 21 has reached the abnormal target position.

Preferably, the first blocking protrusion 2211 and the second blocking protrusion 2213 of the lock plate 221 of the lock body 22 are both located on the upper side of the lock plate 221, and the rotation transmission element 24 is suspended on the upper side of the lock plate 21 by the stepper motor assembly 10. In this way, the overall structure of the door lock apparatus 100 can be more compact, so that the door lock apparatus 100 has a smaller volume, thereby making the door lock apparatus 100 particularly suitable for the cooking utensil.

Preferably, referring to FIGS. 8 to 21, the lock body 22 further comprises at least one mounting arm 223 extending upward from the lock plate 221. The stepper motor assembly 10 is mounted on the mounting arm 223 of the lock body 22, thus the stepper motor assembly 10 and the lock body assembly 20 are assembled as a whole. More preferably, the lock body 22 has two mounting arms 223, so that the stepper motor assembly 10 can be stably mounted on the lock body 22, thereby improving the reliability of the door lock apparatus 100.

In this specific example of the door lock apparatus 100 of the present invention shown in FIGS. 8 to 21, the lock body 22 is a sheet metal part, which is stamped and/or bent at different positions to form the lock plate 221, the lock wall 222 and the mounting arm 223, and the lock plate 221 forms the first blocking protrusion 2211, the second blocking protrusion 2213 and the guide groove 2212.

Referring again to FIGS. 16 to 21, after the door 300 rotates to the position of closing the food channel 202 of the cooking body 200, firstly, a pulse voltage is input to the stepper motor assembly 10, causing the stepper motor assembly 10 to output power by rotating the output shaft 11 counterclockwise. The stepper motor assembly 10 drives the lock hook 21 to swing upward to the release target position through the rotational transmission element 24 and the sliding transmission element 23. Secondly, a pulse voltage is input to the stepper motor assembly 10, causing the stepper motor assembly 10 to output power by rotating the output shaft 11 clockwise. The stepper motor assembly 10 drives the lock hook 21 to swing downward through the rotational transmission element 24 and the sliding transmission element 23. During this process, the pulse voltage input to the stepper motor assembly 10 is calculated. Third, if the stepper motor assembly 10 stalls, the input pulse count is compared with the preset pulse count. If the input pulse count matches the preset pulse count, it is determined that the lock hook 21 has reached the locking target position, that is, the locking end 212 of the lock hook 21 hooks the locking lug 303 of the door 300. At this time, the door 300 prevents the user from opening it. If the input pulse count is greater than the preset pulse count, it is determined that the lock hook 21 has reached the abnormal target position, that is, the locking end 212 of the lock hook 21 has not hooked the locking lug 303 of the door 300. In order to avoid the safety hazards caused to the user by starting the cooking utensil, the cooking utensil can remind the user to check whether the door 300 of the cooking utensil is closed properly. This is crucial for the user's safe use of the cooking utensil.

According to one aspect of the present invention, the present invention provides a method for locking the door of the cooking utensil, wherein the locking method comprises the following steps:
(a) allowing the output shaft 11 of the stepper motor assembly 10 to rotate in one direction so that the stepper motor assembly 10 drives the lock hook 21 to swing in one direction with respect to the lock body 22;
(b) when the stepper motor assembly 10 stalls, confirming that the lock hook 21 has reached the release target position;
(c) allowing the output shaft 11 of the stepper motor assembly 10 to rotate in the opposite direction so that the stepper motor assembly 10 drives the lock hook 21 to swing with respect to the lock body 22 in the opposite direction;
(d) calculate the number of pulses of the pulse voltage input to the stepper motor assembly 10; and
(e) comparing the input pulse count with the preset pulse count, if the stepper motor assembly 10 stalls when the input pulse count and the preset pulse count are the same, then the lock hook 21 is confirmed to have reached the locking target position. If the stepper motor assembly 10 does not stall when the input pulse count is greater than the preset pulse count, then the lock hook 21 is confirmed to have reached the abnormal target position.

Specifically, in one specific example of the present invention, a pulse voltage is input to the stepper motor assembly 10 to cause the stepper motor assembly 10 to output power by rotating the output shaft 11 counterclockwise. The stepper motor assembly 10 drives the lock hook 21 to swing upward to the release target position through the rotational transmission element 24 and the sliding transmission element 23. The release target position is the reference position when the door lock apparatus 100 locks the door. Alternatively, a pulse voltage is input to the stepper motor assembly 10 to cause the stepper motor assembly 10 to output power by rotating the output shaft 11 clockwise. The stepper motor assembly 10 drives the lock hook 21 to swing downward through the rotational transmission element 24 and the sliding transmission element 23. During this process, the number of pulses of the pulse voltage input to the stepper motor assembly 10 can be calculated. During the process of the stepper motor assembly 10 driving the lock hook 21 to swing downward through the rotational transmission element 24 and the sliding transmission element 23, the locking method continuously compares the input pulse number with the preset pulse number. If the stepper motor assembly 10 stalls when the input pulse number and the preset pulse number are the same, the locking method confirms that the lock hook 21 has reached the locking target position. If the stepper motor assembly 10 does not stall when the input pulse number is greater than the preset pulse number, the locking method confirms that the lock hook 21 has reached the abnormal target position.

According to one aspect of the present invention, the present invention provides a method for detecting the position of the lock hook of the door lock apparatus 100, wherein the method for detecting the position of the lock hook comprises the following steps:
(I) inputting a pulse voltage to the stepper motor assembly 10 to allow the stepper motor assembly 10 to drive the lock hook 21 to swing with respect to the lock body 22;
(II) obtaining the back electromotive force value of the stepper motor assembly 10;
(III) determining whether the back electromotive force is 0 when the pulse voltage is 0, in order to determine whether the stepper motor assembly 10 is stalled; and
(IV) when the stepper motor assembly 10 stalls, confirming that the lock hook 21 has reached the target position.

According to one aspect of the present invention, the present invention provides a method for detecting the position of the lock hook of the door lock apparatus 100, wherein the method for detecting the position of the lock hook comprises the following steps:
(A) inputting a pulse voltage to the stepper motor assembly 10 to allow the stepper motor assembly 10 to drive the lock hook 21 to swing with respect to the lock body 22;
(B) obtaining the current value of the stepper motor assembly 10;
(C) determining whether the stepper motor assembly 10 is stalled based on the current change value ΔI at adjacent time intervals ; and
(D) when the stepper motor assembly 10 stalls, confirming that the lock hook has reached the target position.

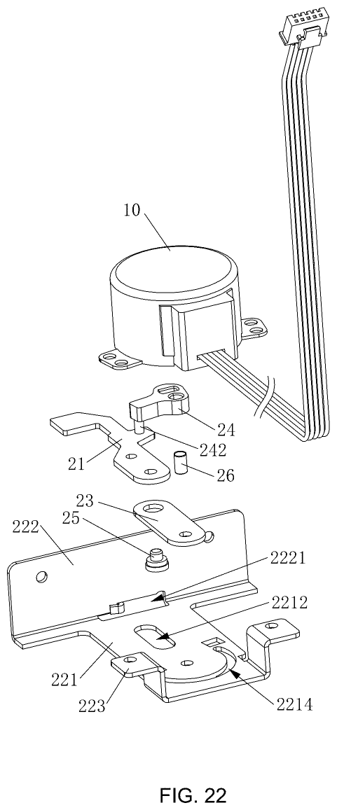

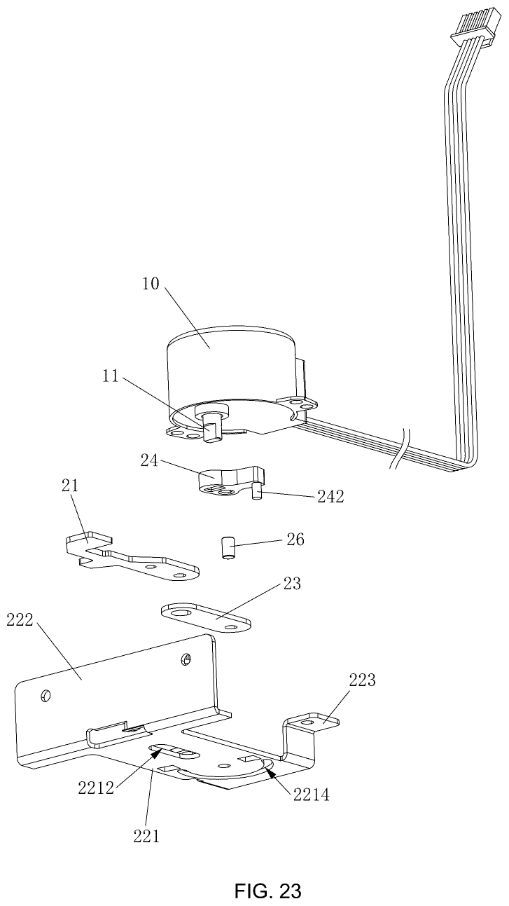

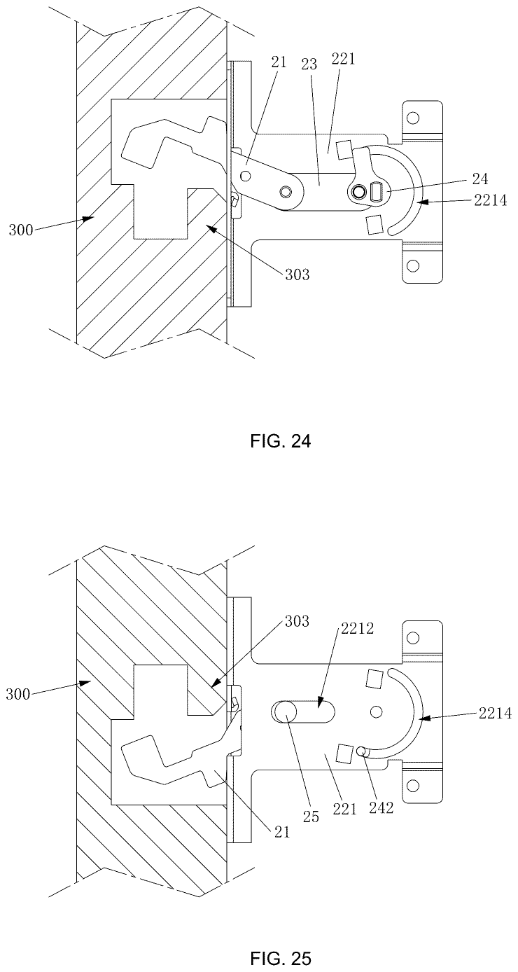

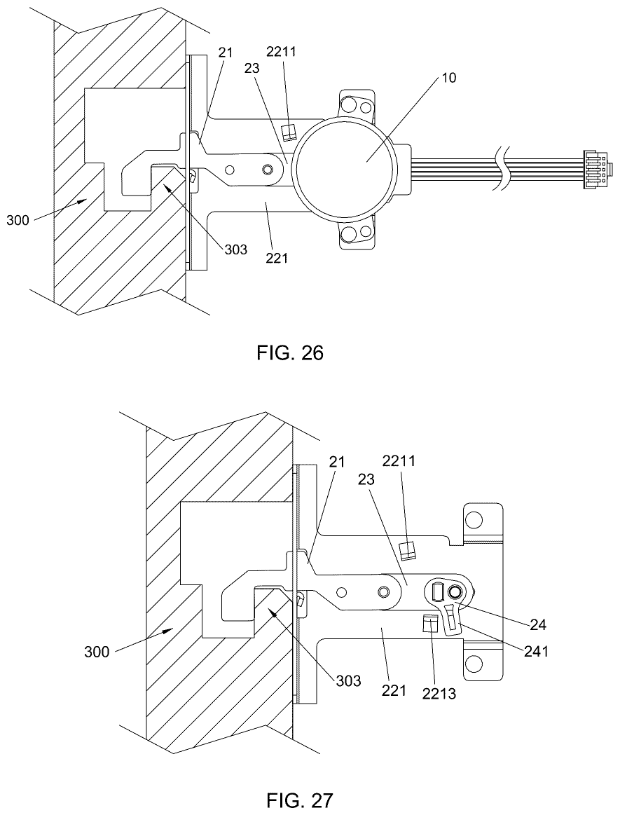

FIGS. 22 to 27 show a modified example of the door lock apparatus 100 of the present invention. Unlike the door lock apparatus 100 shown in FIGS. 8 to 21, in this specific example of the door lock apparatus 100 shown in FIGS. 22 to 27, the lock plate 221 of the lock body 22 has an arcuate groove 2214, and the bottom of the rotational transmission element 24 has a limiting protrusion 242. The limiting protrusion 242 of the rotational transmission element 24 is movably extended into the arcuate groove 2214 of the lock plate 221. (Refer to FIGS. 24 and 25) When the stepper motor assembly 10 drives the lock hook 21 to swing upward with respect to the lock body 22 via the rotation transmission element 24 and the sliding transmission element 23, the limiting protrusion 242 of the rotation transmission element 24 can be blocked by the inner wall of the lock plate 221 that forms the arcuate groove 2214, thereby causing the stepper motor assembly 10 to stall. At this time, the lock hook 21 reaches the release target position, as shown in FIGS. 26 and 27. When the stepper motor assembly 10 drives the lock hook 21 to swing downward with respect to the lock body 22 through the rotational transmission element 24 and the sliding transmission element 23, the locking end 212 of the lock hook 21 can hook the locking lug 303 of the door 300, so that the stepper motor assembly 10 is blocked. At this time, the lock hook 21 reaches the locking target position. During this process, if the door 300 is not closed in place, the inner wall of the lock plate 221 for forming the arc groove 2214 can block the limiting protrusion 242 of the rotational transmission element 24, so that the stepper motor assembly 10 is blocked. At this time, the lock hook 21 reaches the abnormal target position.

Therefore, it can be seen that the objective of the present invention can be fully and effectively achieved. The embodiments used to explain the functional and structural principles of the present invention have been fully described and illustrated, and the present invention is not limited to changes based on the principles of these embodiments. Therefore, the present invention comprises all modifications covered within the scope and spirit of the appended claims.

1-27. (canceled)

28. A door lock apparatus, wherein the door lock apparatus comprises a stepper motor assembly and a lock body assembly, wherein the stepper motor assembly has an output shaft, wherein the lock body assembly comprises:
a lock hook having a connecting end and a locking end opposite to the connecting end, wherein the locking end is a hook end;
a lock body comprising a lock plate and a lock wall integrally extended upward from the lock plate, the lock plate has a first blocking protrusion, the lock wall has a hook channel, wherein a middle portion of the lock hook is pivotally disposed in the hook channel of the lock wall;
a sliding transmission element slidably disposed on the lock plate, and a first end of the sliding transmission element is rotatably mounted to the connecting end of the lock hook; and
a rotation transmission element comprising a swing arm on a side thereof, a first position of the rotation transmission element is rotatably mounted to a second end of the sliding transmission element, and a second position of the rotation transmission element is drivably mounted to the output shaft of the stepper motor assembly, the first blocking protrusion of the lock plate is located on a first side of the rotation transmission element, wherein when the stepper motor assembly drives the rotation transmission element to rotate, the rotation transmission element drives the lock hook to swing with respect to the lock body through the sliding transmission element, and the swing arm of the rotation transmission element is allowed to be blocked by the first blocking protrusion of the lock plate.

29. The door lock apparatus according to claim 28, wherein the lock plate has a second blocking protrusion located on a second side of the rotation transmission element, wherein when the stepper motor assembly drives the rotation transmission element to rotate, the swing arm of the rotation transmission element is allowed to be blocked by the second blocking protrusion of the lock plate.

30. The door lock apparatus according to claim 28, wherein the first blocking protrusion is provided on an upper side of the lock plate, and the rotational transmission element is suspended on an upper side of the lock plate by the stepper motor assembly.

31. The door lock apparatus according to claim 29, wherein the first blocking protrusion and the second blocking protrusion are disposed on an upper side of the lock plate, and the rotational transmission element is suspended on an upper side of the lock plate by the stepper motor assembly.

32. The door lock apparatus according to claim 30, wherein the lock body comprises a mounting arm extended integrally upward from the lock plate, and the stepper motor assembly is mounted on the mounting arm.

33. The door lock apparatus according to claim 31, wherein the lock body comprises a mounting arm extended integrally upward from the lock plate, and the stepper motor assembly is mounted on the mounting arm.

34. The door lock apparatus according to claim 28, wherein the lock plate has a guide groove, wherein the lock body assembly further comprises a guide element disposed on the sliding transmission element and slidably disposed in the guide groove of the lock plate.

35. The door lock apparatus according to claim 29, wherein the lock plate has a guide groove, wherein the lock body assembly further comprises a guide element disposed on the sliding transmission element and slidably disposed in the guide groove of the lock plate.

36. The door lock apparatus according to claim 30, wherein the lock plate has a guide groove, wherein the lock body assembly further comprises a guide element disposed on the sliding transmission element and slidably disposed in the guide groove of the lock plate.

37. The door lock apparatus according to claim 31, wherein the lock plate has a guide groove, wherein the lock body assembly further comprises a guide element disposed on the sliding transmission element and slidably disposed in the guide groove of the lock plate.

38. The door lock apparatus according to claim 34, wherein at least one of the connecting end of the lock hook and the first end of the sliding transmission element is rotatably mounted to the guide element.

39. The door lock apparatus according to claim 35, wherein at least one of the connecting end of the lock hook and the first end of the sliding transmission element is rotatably mounted to the guide element.

40. The door lock apparatus according to claim 36, wherein at least one of the connecting end of the lock hook and the first end of the sliding transmission element is rotatably mounted to the guide element.

41. The door lock apparatus according to claim 37, wherein at least one of the connecting end of the lock hook and the first end of the sliding transmission element is rotatably mounted to the guide element.

42. The door lock apparatus according to claim 28, wherein the stepper motor assembly is configured to be input a pulse voltage to allow the stepper motor assembly to drive the lock hook to swing with respect to the lock body, wherein when a back electromotive force value of the stepper motor assembly is 0 when the pulse voltage is 0, the stepper motor assembly is determined to be stalled, so as confirm that the lock hook has reached a target position.

43. The door lock apparatus according to claim 28, wherein the stepper motor assembly is configured to be input a pulse voltage to allow the stepper motor assembly to drive the lock hook to swing with respect to the lock body, wherein the stepper motor assembly is determined to be stalled based on a current change value at adjacent time intervals, so as confirm that the lock hook has reached a target position.

44. The door lock apparatus according to claim 42, wherein the lock hook is confirmed to have reached a release target position, a locking target position, or an abnormal target position based on an input method of the pulse voltage of the stepper motor assembly, wherein when the stepper motor assembly drives the lock hook to swing from the release target position to the locking target position, the number of pulses input to the stepper motor assembly is calculated, when the stepper motor assembly stalls, the input number of pulses is compared with a preset number of pulses, if the input number of pulses is consistent with the preset number of pulses, it is confirmed that the lock hook has reached the locking target position, if the input number of pulses is greater than the preset number of pulses, it is confirmed that the lock hook has reached the abnormal target position.

45. The door lock apparatus according to claim 43, wherein the lock hook is confirmed to have reached a release target position, a locking target position, or an abnormal target position based on an input method of the pulse voltage of the stepper motor assembly, wherein when the stepper motor assembly drives the lock hook to swing from the release target position to the locking target position, the number of pulses input to the stepper motor assembly is calculated, when the stepper motor assembly stalls, the input number of pulses is compared with a preset number of pulses, if the input number of pulses is consistent with the preset number of pulses, it is confirmed that the lock hook has reached the locking target position, if the input number of pulses is greater than the preset number of pulses, it is confirmed that the lock hook has reached the abnormal target position.

46. The door lock apparatus according to claim 28, wherein the door lock apparatus is provided on a cooking utensil, wherein the cooking utensil comprises a cooking body having a cooking space and a food passage communicated with the cooking space, and a door having a pivot side, a locking side opposite to the pivot side, and a locking lug located on the locking side, the pivot side of the door is rotatably mounted to the cooking body, and the door is capable of closing the food passage of the cooking body, wherein the door lock apparatus is provided on the cooking body, wherein the lock hook of the door lock apparatus is configured to release or hook the locking lug of the door.

47. The door lock apparatus according to claim 34, wherein the door lock apparatus is provided on a cooking utensil, wherein the cooking utensil comprises a cooking body having a cooking space and a food passage communicated with the cooking space, and a door having a pivot side, a locking side opposite to the pivot side, and a locking lug located on the locking side, the pivot side of the door is rotatably mounted to the cooking body, and the door is capable of closing the food passage of the cooking body, wherein the door lock apparatus is provided on the cooking body, wherein the lock hook of the door lock apparatus is configured to release or hook the locking lug of the door.
